(19) United States
(12) Patent Application Publication
(10) Pub. No.: US 2022/0358442 A1
(43) Pub. Date: Nov. 10, 2022

(54) SYSTEMS, AND METHODS FOR DATA COLLECTION ANALYSIS

(71) Applicant: OLME.US LLC, New York, NY (US)

(72) Inventors: Ariella Azogui, New York, NY (US); Marcus Hoed, New York, NY (US)

(73) Assignee: OLME.US LLC, New York, NY (US)

(21) Appl. No.: 17/736,999

(22) Filed: May 4, 2022

Related U.S. Application Data
(60) Provisional application No. 63/184,186, filed on May 4, 2021.

(51) Int. Cl. G06Q 10/06; G06Q 10/10; G06V 30/30

(52) U.S. Cl. CPC G06Q 10/06398; G06Q 10/1091; G06V 30/30

(57) ABSTRACT

A method for data collection and analysis may include generating one or more screenshots; converting the screenshot, via OCR, into one or more strings of computer-readable text; detecting one or more variables from the computer-readable text; retrieving, additional variables via one or more modules; and displaying, via a video display device, a dashboard. The dashboard may include one or more configurable views, and each configurable view may include a visual representation of one or more variables.

### CLAIM OF PRIORITY

This application claims priority from U.S. Provisional Application No. 63/184,186, filed on May 4, 2021, the contents of which are incorporated herein by reference.

### FIELD OF THE INVENTION

The present disclosure relates to systems, and methods for data collection analysis. Specifically, this disclosure relates to systems, and methods for data collection analysis processes tailored to analyzing data collected from low-skill workers.

### INTRODUCTION

The majority of companies in the “gig” economy hire individuals as 1099 — Independent Contractors. Unfortunately, when doing so, the individual contractor is less connected to the work and/or company. Thus, the contractor does not always demonstrate a commitment in their attendance, which impacts performance. This issue also raises serious liability for companies because state and federal agencies closely review misclassification of individuals working with companies in “gig” industries.

Many “gig” industries do not work with 1099—Independent Contractors (for example, for delivery associate positions). Many of these workers are hired as W2 employees. This enables many of these companies to control scheduling. Controlling scheduling also enables the company to better meet clients' staffing needs, set enforceable performance standards for delivery associates, cross train employees among various client groups/operations and, finally, insulates the company from exposure to any misclassification liability.

The labor pool for the delivery associate positions are lower level, entry level, minimum wage workers with limited or no work experience and up to high school level education. Accordingly, many of these workers are not familiar with integrated systems that contain “user portals,” updated technology, etc.

Often, these kinds of workers (for example, delivery associates) work remotely, often at client sites. Since these are entry-level individuals, often their ability to work independently, their ability to demonstrate ownership of their work assignments ensuring the timely delivery of goods, and/or ability to consistently follow company policy related to clock in/clock out protocol is limited. Moreover, training in the traditional, “old school” way regarding these necessary behaviors is not well received among this population, as many are not comfortable with the “school” approach to learning.

Like many entry-level positions, the individuals who are filling these roles live “pay check to pay check.” This makes it difficult for employees who are in need of money but must wait “until the next check” to access the wages they are entitled to. Often this leads to poor attendance, frustration, and poor work habits.

Therefore, it would be ideal to have systems, methods, and apparatuses configured to act as platforms for data collection. It would further be ideal to have data collection analysis processes tailored to analyzing data collected from low-skill workers.

### SUMMARY

In an aspect of the present disclosure, a method for data collection and analysis may include generating one or more screenshots; converting the screenshot, via OCR, into one or more strings of computer-readable text; detecting one or more variables from the computer-readable text; retrieving, additional variables via one or more modules; and displaying, via a video display device, a dashboard. The dashboard may include one or more configurable views, and each configurable view may include a visual representation of one or more variables.

In an embodiment, the variable may include one of an employee's name, Order ID, Package ID, delivery status, pickup address, or delivery address.

In another embodiment, the one or more modules may include a Mapping Payroll Position & Type Module, or a Gross Earnings File Module.

In yet another embodiment, the one or more screenshots may be generated via a bot which automates user actions.

In a further embodiment, the one or more screenshots may be generated at a set frequency.

In an embodiment, the frequency may be every ten seconds.

In an aspect of the present disclosure, a system for data collection and analysis may include one or more processors, one or more computer-readable memories, and one or more computer-readable storage devices, and program instructions stored on at least one of the one or more computer-readable storage devices for execution by at least one of the one or more processors via at least one of the one or more computer-readable memories, the stored program instructions may include generating one or more screenshots; converting the screenshot, via OCR, into one or more strings of computer-readable text; detecting one or more variables from the machine readable text; retrieving, additional variables via one or more modules; and displaying, via a video display device, a dashboard. The dashboard may include one or more configurable views, and each configurable view may include a visual representation of one or more variables.

In an embodiment, the variable may include one of an employee's name, Order ID, Package ID, delivery status, pickup address, or delivery address.

In another embodiment, the one or more modules may include a Mapping Payroll Position & Type Module, or a Gross Earnings File Module.

In yet another embodiment, the one or more screenshots may be generated via a bot which automates user actions.

In a further embodiment, the one or more screenshots may be generated at a set frequency.

In an embodiment, the frequency may be every ten seconds.

These and other aspects, features, and advantages of the present invention will become more readily apparent from the following drawings and the detailed description of the preferred embodiments.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 is an illustrative block diagram of a system based on a computer.

FIG. 2 is an illustration of a computing machine.

FIG. 3 illustrates a visual representation of an employee's overtime according to aspects of the present disclosure.

FIG. 4 illustrates a visual representation of salary or paycheck information based on the hours worked and the employee's wage according to aspects of the present disclosure.

FIG. 5 illustrates a visual representation of a spread hours report according to aspects of the present disclosure.

FIG. 6 illustrates a visual representation of unapproved locations and/or times according to aspects of the present disclosure.

FIG. 7 illustrates a workflow according to various aspects of the present disclosure.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or process the software in a distributive manner by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” as used herein typically includes and refers to executable instructions, code, data, applications, programs, program modules, or the like maintained in an electronic device such as a ROM. The term “software” as used herein typically includes and refers to computer-executable instructions, code, data, applications, programs, program modules, firmware, and the like maintained in or on any form or type of computer-readable media that is configured for storing computer-executable instructions or the like in a manner that may be accessible to a computing device.

The terms “computer-readable medium”, “computer-readable media”, and the like as used herein and in the claims are limited to referring strictly to one or more statutory apparatus, article of manufacture, or the like that is not a signal or carrier wave per se. Thus, computer-readable media, as the term is used herein, is intended to be and must be interpreted as statutory subject matter.

The term “computing device” as used herein and in the claims is limited to referring strictly to one or more statutory apparatus, article of manufacture, or the like that is not a signal or carrier wave per se, such as computing device 101 that encompasses client devices, mobile devices, wearable devices, one or more servers, network services such as an Internet services or corporate network services based on one or more computers, and the like, and/or any combination thereof. Thus, a computing device, as the term is used herein, is also intended to be and must be interpreted as statutory subject matter.

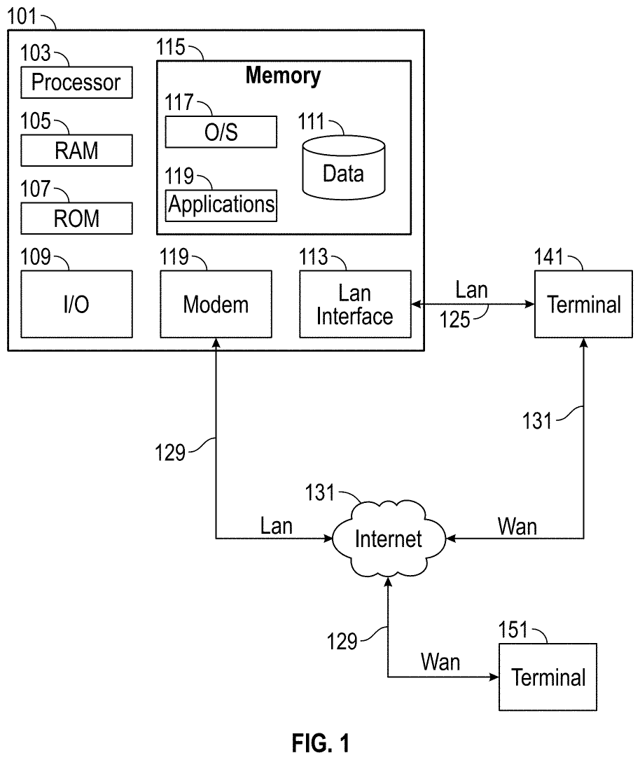

FIG. 1 is an illustrative block diagram of system 100 based on a computer 101. The computer 101 may have a processor 103 for controlling the operation of the device and its associated components, and may include RAM 105, ROM 107, input/output module 109, and a memory 115. The processor 103 will also execute all software running on the computer—e.g., the operating system. Other components commonly used for computers such as EEPROM or Flash memory or any other suitable components may also be part of the computer 101.

The memory 115 may be comprised of any suitable permanent storage technology—e.g., a hard drive. The memory 115 stores software including the operating system 117 any application(s) 119 along with any data 111 needed for the operation of the system 100. Alternatively, some or all of computer executable instructions may be embodied in hardware or firmware (not shown). The computer 101 executes the instructions embodied by the software to perform various functions.

Input/output (“I/O”) module may include connectivity to a microphone, keyboard, touch screen, and/or stylus through which a user of computer 101 may provide input, and may also include one or more speakers for providing audio output and a video display device for providing textual, audiovisual and/or graphical output.

System 100 may be connected to other systems via a LAN interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program(s) 119, which may be used by computer 101, may include computer executable instructions for invoking user functionality related to communication, such as email, Short Message Service (SMS), and voice input and speech recognition applications.

Computer 101 and/or terminals 141 or 151 may also be devices including various other components, such as a battery, speaker, and antennas (not shown).

Terminal 151 and/or terminal 141 may be portable devices such as a laptop, cell phone, smartphone, smartwatch, or any other suitable device for storing, transmitting and/or transporting relevant information. Terminals 151 and/or terminal 141 may be other devices. These devices may be identical to system 100 or different. The differences may be related to hardware components and/or software components.

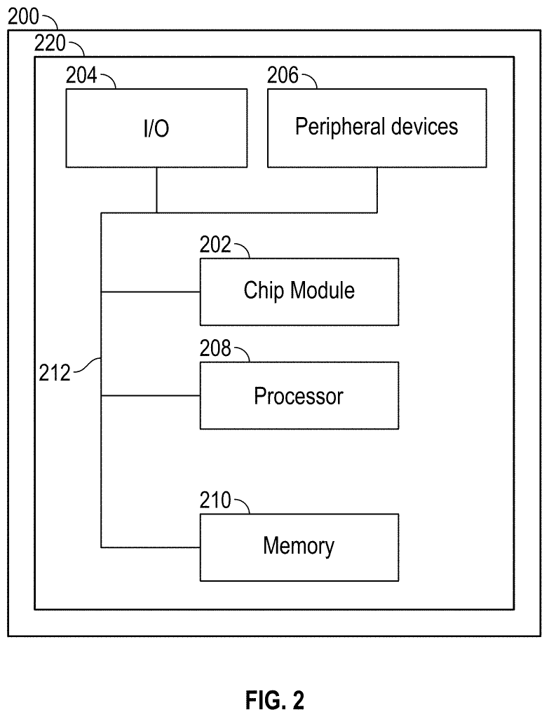

FIG. 2 shows illustrative apparatus 200. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may test submitted information for validity, scrape relevant information, aggregate user financial data and/or provide an auth-determination score(s) and machine-readable memory 210.

Machine-readable memory 210 may be configured to store in machine-readable data structures: information pertaining to a user, information pertaining to an account holder and the accounts which be may hold, the current time, information pertaining to historical user account activity and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

An aspect of the present disclosure may include a system for data collection analysis. The system may include a dashboard in which all information related to an employee's time and attendance, work assignments, and remote site locations may be collected. Such information may be displayed to a user via the dashboard. In an embodiment, the data may then be analyzed and automatically approved or denied for payroll processing, a company's policy violations, and/or performance management and data trends. Elements and exemplary embodiments of the dashboard are discussed in greater detail below.

The system may obtain data from a variety of sources. For example, the system may be configured to work with external software such as HUMANITY. The system may include a Mapping Payroll Position & Type Module. The module may enable the user to map a HUMANITY position to a payroll type. Accordingly, after the mapping, the system may determine the payroll type of a specific HUMANITY position. From the frontend, the user may navigate to a mapping position payroll type interface. The interface may present the list of HUMANITY's positions. A list of payroll types may be correlated to each position on the interface. Accordingly, the interface may allow the user to select a payroll type for the position he or she wants to map. In the backend, a request may be sent to the server such that the server updates the list of positions already selected for a specific payroll type in the database. In an embodiment, once a position is mapped with a payroll type, the menu may be disabled so the mapping cannot be altered. For example, this may be implemented because a HUMANITY position is associated with a single Payroll type. Thus, if the payroll type changes, a new position may be created to maintain the coherence of the original time clock related to the originally selected position.

The system may further include a Gross Earnings File Module. Such module may retrieve approved clock data from HUMANITY for the last month. However, any suitable time interval may be used. Next, the module may organize the clock data by work date and/or employee ID. In an embodiment, the module then calculates the total worked hours using an algorithm. The algorithm may perform the following: 1) begin with a total worked hours value of 0; 2) retrieve the current total worked hours for the current work week for a specific employee; 3) if the sum of current total worked hours for the current work week and the total hours worked that day is less than 40, then the total worked hours will be updated to include the total hours worked that day, which is the difference between the time clock start and the time clock end for that day; 4) if the current total worked hours for the current work week is less than 40, and the sum of current total worked hours for the current work week and the total hours worked that day is greater than 40, then the total worked hours will be updated to 40, which is achieved by defining the shift end time as equal to the shift start time and adding the difference between 40 and the current total worked hours for the current work week; 5) if the current total worked hours for the current work week is equal to 40, then the shift end time will equal the shift start time, resulting in 0 hours being added to the total worked hours.

The Gross Earnings File Module may generate a table via an algorithm. The table may include columns such as user_id, pay_group, shift_date, shift_earnings, shift_started_at, shift_ended_at, shift_hours, and pay_rate, which may be defined as follows:

| | |
|---|---|
| user_id | employee humanity EID |
| pay_group | employee ADP pay group |
| shift_date | time clock work date |
| shift_earnings | equal the multiplication of shift_hours and pay_rate |
| shift_started_at | Humanity time clock start time |
| shift_ended_at | Humanity time clock end time |
| shift_hours | total hours calculated with new time clock (after |
| | calculating the total worked hours in each week |
| | and update time clock start and time clock end) |
| pay_rate | employee ADP pay rate |

The table may be converted into a CSV file, or any suitable database file such as XML or SQLite, which may be sent through SFTP to daily pay servers once per hour. However, any suitable time interval may be used.

The system may import data obtained from any of the aforementioned modules into the dashboard. Such data may be displayed to the user, or processed with other data obtained from other modules.

In embodiment, the system includes a client independent module (for example, configurable for all clients). The system may filter the client along with the date and the operation by using any number or combination of filters.

In an embodiment, the system may filter by user interface/user experience for date and program selection mechanisms (for example, filters with small calendars and program lists instead of various buttons and obtrusive calendars).

In an embodiment, the system provides improved listing for a table (for example, enabling the user to see additional information). The system may be configured to expand the current row of displayed tables instead of displaying the information in a popup window.

The system may include more than one configurable view. In an embodiment, a user may choose between each configurable view. Each configurable view may include certain information pertaining one or more employees. In such an embodiment, information may be sorted by temporal order or by employee name.

In an embodiment, the system may collect information from the employee and/or employer. The information may include: the employee's name, first scan (time and location of the first pickup), last scan (time and location of the last delivery), Order ID or Package ID, delivery status (for example, delivered or not delivered), pickup address (for example, acquiring the geoposition by using a third party geolocation API like Google Maps), and delivery address (for example, acquiring the geoposition by using a third party geolocation API like Google Maps). The system may also include operations mapping (for example, a per delivery window). However, in another embodiment, the system may collect any suitable information from the employer or employee.

The system may be able to automate user processes under restricted conditions. In an embodiment, screenshots may be used to capture information from the user's or employee's pages. The system may utilize Optical Character Recognition to convert the captured information into computer-readable text for storage and processing. A user may capture a screenshot after manually moving to the next page of a software program. In an embodiment, to capture one employee's data one may complete the following actions: click on the employee's name on the main page; take a screenshot of the employee's page; click on the progress chart; take a screenshot of the employee's page with the progress chart; navigate to each pickup; take a screenshot of the pickup page; click the software's back button; navigate to each delivery; click the software's back button; and take a screenshot of each delivery.

In an embodiment, the captured information may include unwanted segments of data. For example, the captured information may include advertising graphics or otherwise superfluous information. In an embodiment, the image may be optimized. In such an embodiment, the screenshot may be configured to capture only the necessary segments of the source. For example, if a web portal includes various information pages for each employee, with each page having the same company logo occupying the top third of the page, the screenshot may be configured to capture only the bottom two thirds of the page. The necessary segments of the captured information may be manually configured, but then automatically applied to future captures. It is anticipated that the initial configuration may be configured automatically via a machine learning algorithm. For example, the machine learning algorithm may automatically detect sensitive information, and accordingly exclude that are from screenshot captures. In another embodiment, the page may include an image of a map, which may be removed during optimization by tailoring the dimensions of the screenshots.

In an embodiment, the system may extract data from the computer-readable text in various manners. In one embodiment, the system may be seeded with various text strings associated with one or more variables. For example, the system may be configured to correlate the text string “employee_check_in_time” with the variable for an employee's check-in time. In such an embodiment, the system may further be configured to identify text appearing immediately after (or any other relative position) as the variable's value. For example, given the following portion of text, “employee_check_in_time_10:01_AM,” the system may correlate “employee_check_in_time” as the employee check in variable and “10:01_AM” as the employee check in value. The system may be able to detect errors in certain fields. For example, the following portion of text, “employee_check_in_time_25:90_AM,” may trigger an error to be displayed to a user as it is an invalid time. In an embodiment, value ranges are set which trigger an error in the event that the text string contains data outside of the set range. This process may be repeated for each set of variables and values, creating a complete dataset.

In an embodiment, a browser extension may be utilized to read a page's code. In such an embodiment, the system and/or the browser may include an interactive button configured to capture the page's content. The page's content may be captured in an image file or a text file. The page's content may be stored in a format including TXT, JPEG, GIF, PNG, or PDF. However, any suitable format may be used. The page's content may be stored on the memory 210. Alternatively, the page's content may be stored, temporarily or permanently, in any suitable computer-readable storage device, locally or via a server.

In an embodiment, the system may automate a user's actions to collect data. In such an embodiment, a layer may be added to automate the actions a user may do (for example, taking screenshots or clicking a button to download a page's code), by using a bot that may do these actions automatically. In an embodiment, use of a bot may save valuable time.

In an embodiment, the system may be configured to automate actions at pre-determined frequencies, such as every 10 seconds. In one embodiment, instead of collecting employee data every few seconds (like a robot would normally do) the system may slow the page-to-page navigation and add wait times between actions (for example, so that the actions appear to be performed by a human). These wait times may fluctuate (for example, randomized) or may be the same time for each instance.

In an embodiment, the system may be configured to prevent the restrictions of data collection. In such an embodiment, the system may be made “invisible.” For example, the data collection mechanism may utilize the aforementioned screenshot and automation methods or other method that does not directly communicate with a website. In such an embodiment, data may be sent instantly without restrictions.

In an embodiment, if it appears that the data collection system can be blocked or otherwise thwarted by a user, such as an employee, then one or a combination of the aforementioned methods may be utilized. For example, combining the screenshot technique, automation of user actions, and adjusting actions frequency. Such an embodiment may act as “bot detection” minimization.

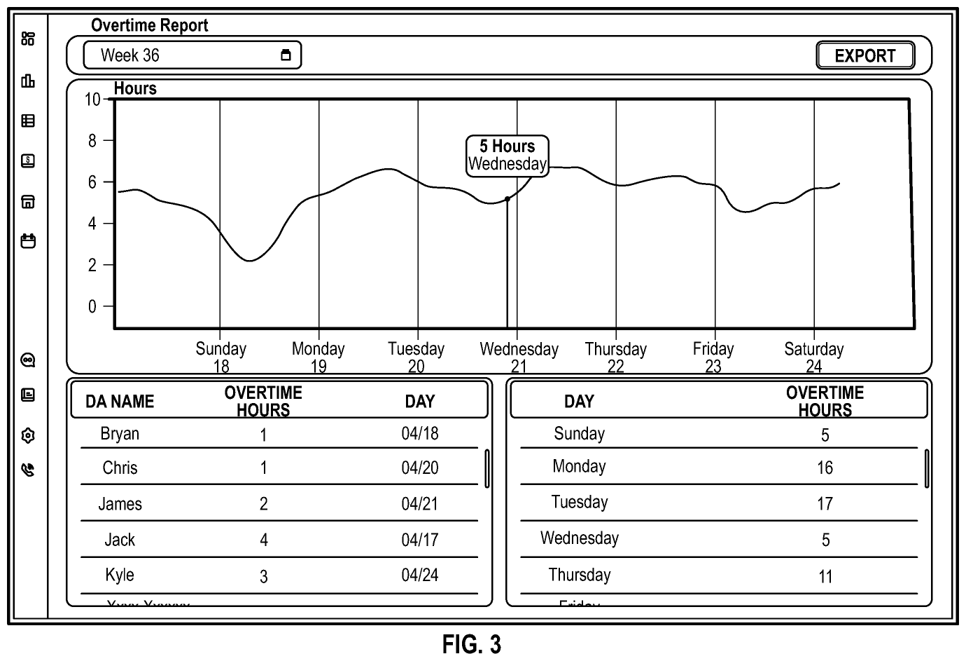

In an embodiment, data collected using the aforementioned methods and systems may be presented in visually appealing or visually helpful graphics on a dashboard (or other location). For example, the system may collect and present data related to an employee's use of overtime. As shown in FIG. 3, the system may output a visual representation of an employee's overtime.

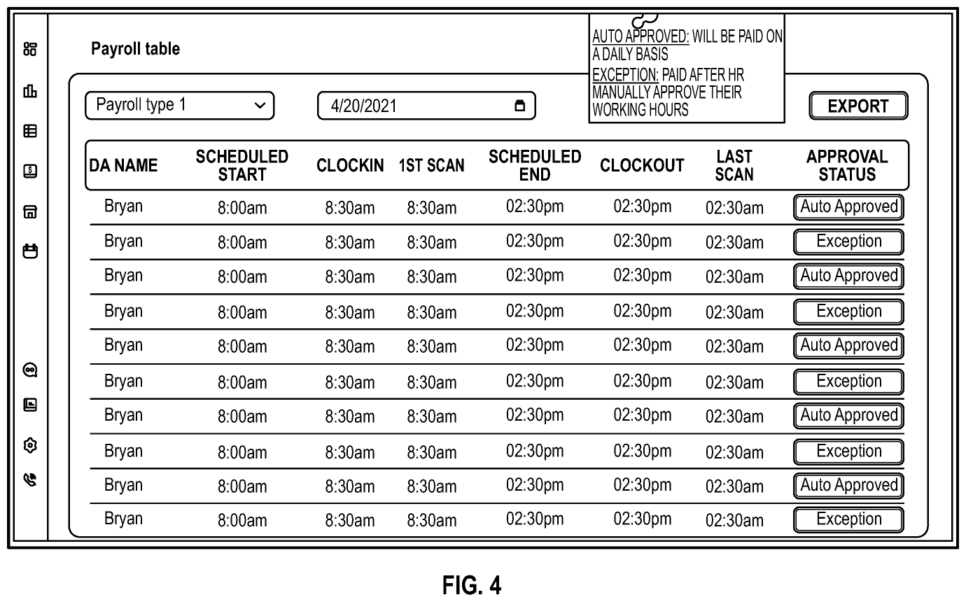

In an embodiment, the data collected may contain information pertaining to an employee's hours. As shown in FIG. 4, the system may calculate the employee's salary or paycheck based on the hours worked and the employee's wage.

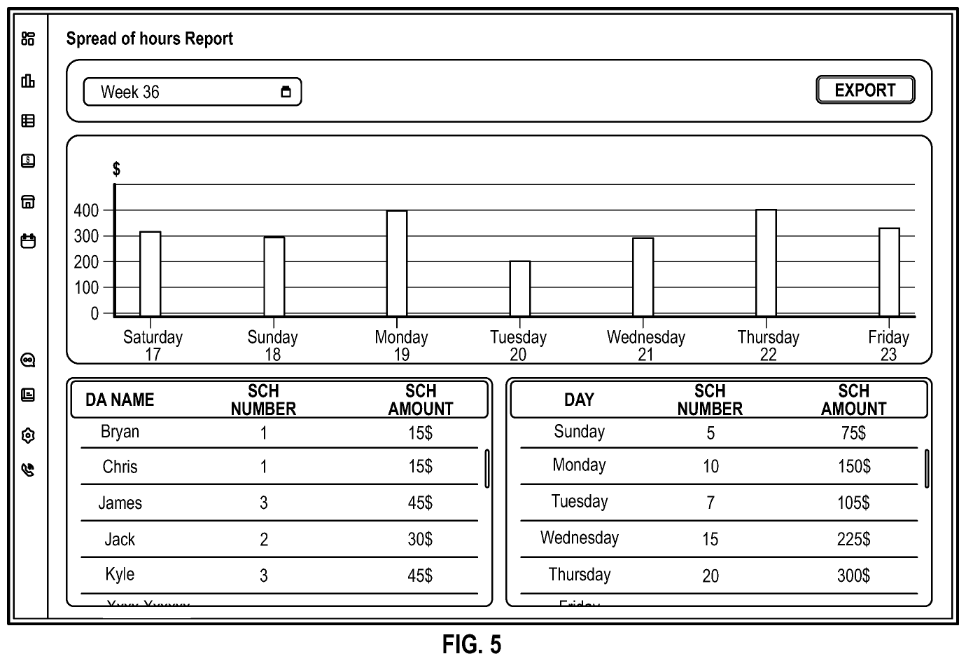

Turning to FIG. 5, in an embodiment, data collected may be used to determine to spread of hours. In doing so, the system may create a visual representation of the spread hours report.

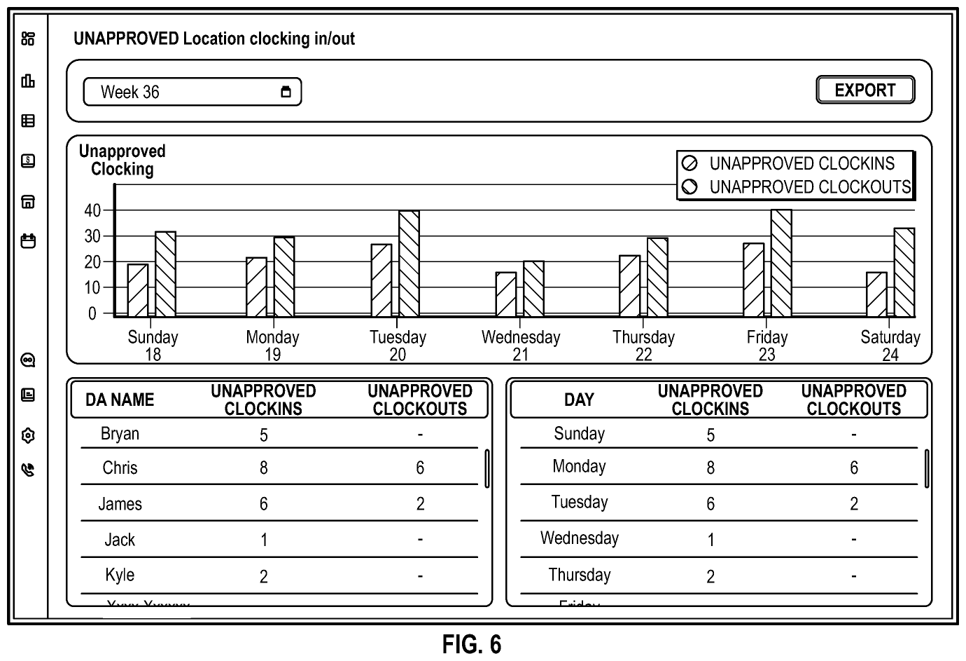

As illustrated in FIG. 6, in an embodiment, data collected may be used to determine unapproved locations of clocking in and/or out. The system may provide a visual representation of the unapproved locations and/or times.

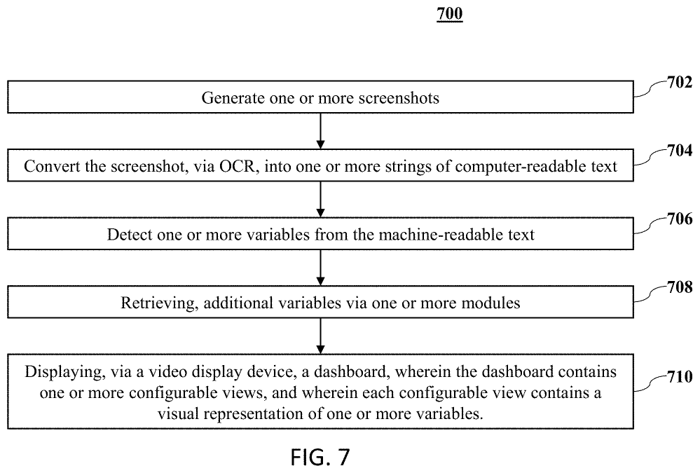

An exemplary method 700 of an aspect of the present disclosure may be shown in FIG. 7. At 702, the system may generate one or more screenshots containing information. Such screenshot may contain any of the information discussed above, such as information from a website or other user interface. At 704, the system may process information in the one or more screenshots using OCR based software. However, any suitable software may be used. Such software may convert information contained within each screenshot into computer-readable text. At 706, the system may analyze the computer-readable text and detect one or more variables, such as clock-in time and clock-out time. Next, at 708, the system may retrieve other variables generated from one or more of the aforementioned modules, such as the Mapping Payroll Position & Type Module, or Gross Earnings File Module. Such data may be stored on a database for later retrieval by the system. In an embodiment, the variables are sorted into different variable categories, such as time, or salary. Finally, at 710, the system may display, via a video display, a dashboard. The dashboard may allow a user to view a visual representation of an employee's performance, or other data metrics, such as income. As discussed the dashboard may be configured into one or more configurable views. Each configurable view may contain a visual representation of the one or more variables. Each view may also include module data which is stored in the database.

In an aspect of the present disclosure, a method for data collection and analysis may include generating one or more screenshots; converting the screenshot, via OCR, into one or more strings of computer-readable text; detecting one or more variables from the computer-readable text; retrieving, additional variables via one or more modules; and displaying, via a video display device, a dashboard. The dashboard may include one or more configurable views, and each configurable view may include a visual representation of one or more variables, or any suitable metric.

In an embodiment, the variable may include one of an employee's name, Order ID, Package ID, delivery status, pickup address, or delivery address. Other variables may include user_id, pay_group, shift_date, shift_earnings, shift_started_at, shift_ended_at, shift_hours, or pay_rate.

In another embodiment, the one or more modules may include a Mapping Payroll Position & Type Module, or a Gross Earnings File Module.

In yet another embodiment, the one or more screenshots may be generated via a bot which automates user actions.

In a further embodiment, the one or more screenshots may be generated at a set frequency.

In an embodiment, the frequency may be every ten seconds.

In an aspect of the present disclosure, a system for data collection and analysis may include one or more processors, one or more computer-readable memories, and one or more computer-readable storage devices, and program instructions stored on at least one of the one or more computer-readable storage devices for execution by at least one of the one or more processors via at least one of the one or more computer-readable memories, the stored program instructions may include generating one or more screenshots; converting the screenshot, via OCR, into one or more strings of computer-readable text; detecting one or more variables from the machine readable text; retrieving, additional variables via one or more modules; and displaying, via a video display device, a dashboard. The dashboard may include one or more configurable views, and each configurable view may include a visual representation of one or more variables.

In an embodiment, the variable may include one of an employee's name, Order ID, Package ID, delivery status, pickup address, or delivery address. Other variables may include user_id, pay_group, shift_date, shift_earnings, shift_started_at, shift_ended_at, shift_hours, or pay_rate.

In another embodiment, the one or more modules may include a Mapping Payroll Position & Type Module, or a Gross Earnings File Module.

In yet another embodiment, the one or more screenshots may be generated via a bot which automates user actions.

In a further embodiment, the one or more screenshots may be generated at a set frequency.

In an embodiment, the frequency may be every ten seconds.

Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A method for data collection and analysis, the method including:
generating one or more screenshots;
converting the screenshot, via OCR, into one or more strings of computer-readable text;
detecting one or more variables from the computer-readable text;
retrieving, additional variables via one or more modules; and
displaying, via a video display device, a dashboard,
wherein the dashboard includes one or more configurable views, and
wherein each configurable view includes a visual representation of one or more variables.

2. The method for data collection and analysis or claim 1, wherein the variable is one of an employee's name, Order ID, Package ID, delivery status, pickup address, or delivery address.

3. The method for data collection and analysis of claim 1, wherein the one or more modules includes:
a Mapping Payroll Position & Type Module; and
a Gross Earnings File Module.

4. The method for data collection and analysis of claim 1, wherein the one or more screenshots are generated via a bot which automates user actions.

5. The method for data collection and analysis of claim 4, wherein the one or more screenshots are generated at a set frequency.

6. The method for data collection and analysis of claim 5, wherein the frequency is every ten seconds.

7. A system for data collection and analysis comprising one or more processors, one or more computer-readable memories, and one or more computer-readable storage devices, and program instructions stored on at least one of the one or more computer-readable storage devices for execution by at least one of the one or more processors via at least one of the one or more computer-readable memories, the stored program instructions comprising:
generating one or more screenshots;
converting the screenshot, via OCR, into one or more strings of computer-readable text;
detecting one or more variables from the computer-readable text;
retrieving, additional variables via one or more modules; and
displaying, via a video display device, a dashboard,
wherein the dashboard includes one or more configurable views, and
wherein each configurable view includes a visual representation of one or more variables.

8. The system for data collection and analysis of claim 7, wherein the variable is one of an employee's name, Order ID, Package ID, delivery status, pickup address, or delivery address.

9. The system for data collection and analysis of claim 7, wherein the one or more modules includes:
a Mapping Payroll Position & Type Module; and
a Gross Earnings File Module.

10. The system for data collection and analysis of claim 7, wherein the one or more screenshots are generated via a bot which automates user actions.

11. The system for data collection and analysis of claim 10, wherein the one or more screenshots are generated at a set frequency.

12. The system for data collection and analysis of claim 11, wherein the frequency is every ten seconds.
